(19) United States
(12) Patent Application Publication
(10) Pub. No.: US 2022/0049109 A1
(43) Pub. Date: Feb. 17, 2022

(54) ANTI-CORROSION TITANIUM DIOXIDE PIGMENTS

(71) Applicant: Tronox LLC, Oklahoma City, OK (US)

(72) Inventors: Quan Su, Edmond, OK (US); Venkata Rama Rao Goparaju, Edmond, OK (US)

(21) Appl. No.: 17/402,303

(22) Filed: Aug. 13, 2021

Related U.S. Application Data
(60) Provisional application No. 63/065,834, filed on Aug. 14, 2020.

(51) Int. Cl. C09D 5/08; C09D 17/00

(52) U.S. Cl. CPC C09D 5/086; C09D 17/003; C09D 17/008

(57) ABSTRACT

An anti-corrosion pigment for use in an aqueous-based coating composition is provided herein. The anti-corrosion pigment disclosed comprises a plurality of titanium dioxide particles; in the range of from about 0.05% by weight to about 1% by weight, based on the total weight of the pigment, of at least one non-volatile, organic hydroxyl amine deposited on the surfaces of the titanium dioxide particles; and in the range of from about 0.02% by weight to about 1% by weight, based on the total weight of the pigment, of at least one organic dispersant deposited on the surfaces of the titanium dioxide particles. The pigment is in dry form. An aqueous-based coating composition, a method of forming a dry anti-corrosion pigment for use in an aqueous-based coating composition, and a method of forming an aqueous-based coating composition are also provided.

### BACKGROUND

This application claims the benefit of prior-filed United States provisional application number 63/065,834, filed on Aug. 14, 2020, the entirety of which is incorporated by reference herein.

Titanium dioxide (TiO₂) is an effective inorganic pigment for use in many types of products, including aqueous-based inks, latex paints, paper, and plastic. For example, titanium dioxide is a very effective white opacifying agent. It can be formed by either the sulfate process or the chloride process and is typically produced in powder form.

In the sulfate process for manufacturing titanium dioxide, a titanium slag ore is dissolved in sulfuric acid to form titanyl sulfate. The titanyl sulfate is then hydrolyzed to form hydrous titanium dioxide. The hydrated titanium dioxide is heated in a calciner to grow titanium dioxide crystals to pigmentary dimensions.

In the chloride process for manufacturing titanium dioxide, a dry titanium dioxide ore is fed into a chlorinator together with coke and chlorine to produce a gaseous titanium halide (such as titanium tetrachloride). The produced titanium halide is purified and oxidized in a specially designed reactor at a high temperature to produce titanium dioxide particles having a desired particle size. Aluminum chloride or some other co-oxidant is typically added to the titanium halide in the oxidation reactor to facilitate rutile formation and control particle size. The titanium dioxide and gaseous reaction products are then cooled and the titanium dioxide particles are recovered.

Whether produced by the sulfate process or the chloride process, the produced titanium dioxide particles are typically coated with one or more inorganic materials to modify or enhance the properties and characteristics of the pigment to fit a particular application. For example, the pigment particles are often coated with compounds that function to improve the opacity, light stability and durability of the pigment. Examples of inorganic materials used to coat titanium dioxide pigments include alumina, silica and zirconia.

A primary property that a titanium dioxide pigment contributes to paint, paper, plastic and other products is hiding power, also referred to as opacity. The hiding power of a titanium dioxide pigment is based on the ability of the pigment to scatter light in the base product (for example, a latex paint formulation). The ability of the pigment to scatter light in the base product to which it is added (in other words, the light scattering efficiency of the pigment) depends on various factors, including the particle size of the pigment, the difference in refractive index of the pigment particles and their surroundings (for example, a large difference in the refractive index of the pigment particles and the base product results in a high scattering efficiency), and the proximity of the pigment particles to one another.

Although not as well known, modified titanium dioxide pigments can also function as corrosion inhibitors in coatings for metal substrates. In fact, due to the hiding power that they can provide, anti-corrosion titanium dioxide pigments are often used in lieu of more traditional anti-corrosion pigments.

Traditionally, metal substrates have been coated with anti-corrosion pigments such as lead-based pigments and chromate-based pigments. Lead-based pigments and chromate-based pigments can be very effective in inhibiting corrosion. However, the fact that such pigments are based on toxic heavy metals can be problematic.

As a result, less toxic anti-corrosion pigments based on, for example, metal phosphates (for example, zinc phosphate), molybdates and calcium silicates have been developed. Unfortunately, these types of pigments can be expensive to manufacture and typically have large particle sizes (for example, greater than a micron). For example, due to a lack of hiding power and opacity, such pigments are often unsuitable for use in high-gloss latex paint formulations. Furthermore, many of the anti-corrosion titanium dioxide pigments developed heretofore are only effective in solvent-based systems. The trend in paints and other coatings is to move from solvent-based systems to aqueous-based systems. However, it can be challenging to form anti-corrosion pigments for use in aqueous-based systems due to the fact many needed components are water-sensitive and therefore not suitable for corrosion protection.

Thus, there is a need for anti-corrosive titanium dioxide pigments that are effective in aqueous-based coatings.

### SUMMARY

In a first aspect, an anti-corrosion pigment for an aqueous-based coating composition is provided. The anti-corrosion pigment comprises a plurality of titanium dioxide particles; in the range of from about 0.05% by weight to about 1% by weight, based on the total weight of the pigment, of at least one non-volatile, organic hydroxyl amine deposited on the surfaces of the titanium dioxide particles; and in the range of from about 0.02% by weight to about 1% by weight, based on the total weight of the pigment, of at least one organic dispersant deposited on the surfaces of the titanium dioxide particles. The organic dispersant is selected from the group consisting of low molecular weight organic dispersants, organic polymeric dispersants, and combinations thereof. The low molecular weight organic dispersants are molecules that contain one or more functional groups derived from compounds selected from the group consisting of phosphonic acids, phosphoric acids, phosphonate-based carboxylic acids, salts of such compounds, and combinations thereof. The organic polymeric dispersants are polymeric molecules that contain one or more functional groups derived from compounds selected from the group consisting of phosphonic acids, phosphoric acids, phosphonate-based carboxylic acids, salts of such compounds, and combinations thereof. The pigment is in dry form.

In a second aspect, an aqueous-based coating composition is provided. The aqueous-based coating composition comprises an aqueous mixture; and an anti-corrosion pigment dispersed in the aqueous mixture. The anti-corrosion pigment is the anti-corrosion pigment of the first aspect described above.

In a third aspect, a method of forming a dry anti-corrosion pigment for use in an aqueous-based coating composition is provided. The dry anti-corrosion pigment formed by the method is the anti-corrosion pigment of the first aspect described above.

In a fourth aspect, a method of forming an aqueous-based coating composition is provided. The aqueous-based coating composition formed by the method is the aqueous-based coating composition of the second aspect described above.

### DETAILED DESCRIPTION

The present disclosure may be understood more readily by reference to this detailed description as well as to the examples included herein. Numerous specific details are set forth in order to provide a thorough understanding of the various aspects of this disclosure. However, it will be understood by those of ordinary skill in the art that the claimed subject matter can be practiced without these specific details. In other instances, methods, procedures and components have not been described in detail in order to avoid obscuring the related relevant feature being described. This detailed description is not to be considered as limiting the scope of the claims. The subject matter disclosed herein is capable of considerable modifications, alterations, combinations, and equivalents in form and function, as will be evident to those skilled in the art with the benefit of this disclosure.

Whenever a range is disclosed herein, the range includes independently and separately every member of the range extending between any two numbers enumerated within the range. Furthermore, the lowest and highest numbers of any range shall be understood to be included within the range set forth.

Unless otherwise indicated, all numbers expressing quantities of ingredients, properties such as molecular weight, reaction conditions, and so forth used in the present specification and associated claims are to be understood as being modified in all instances by the term “about.”

In one aspect, an anti-corrosion pigment for use in an aqueous-based coating composition is provided herein. In another aspect, an aqueous-based coating composition is provided. In yet another aspect, a method of forming a dry anti-corrosion pigment for use in an aqueous-based coating composition is provided. In yet another aspect, a method of forming an aqueous-based metal substrate coating composition is provided.

The anti-corrosion pigment for use in an aqueous-based coating composition that is disclosed herein comprises a plurality of titanium dioxide particles; in the range of from about 0.05% by weight to about 1% by weight, based on the total weight of the pigment, of at least one non-volatile, organic hydroxyl amine deposited on the surfaces of the titanium dioxide particles; and in the range of from about 0.02% by weight to about 1% by weight, based on the total weight of the pigment, of at least one organic dispersant deposited on the surfaces of the titanium dioxide particles. The organic dispersant is selected from the group consisting of low molecular weight organic dispersants, organic polymeric dispersants, and combinations thereof. The low molecular weight organic dispersants are molecules that contain one or more functional groups derived from compounds selected from the group consisting of phosphonic acids, phosphoric acids, phosphonate-based carboxylic acids, salts of such compounds, and combinations thereof. The organic polymeric dispersants are polymeric molecules that contain one or more functional groups derived from compounds selected from the group consisting of phosphonic acids, phosphoric acids, salts of such compounds, phosphonate-based carboxylic acids, and combinations thereof. The pigment is in dry form.

As used herein and in the appended claims, an “anti-corrosion pigment for an aqueous-based coating composition” means a pigment that when added to an aqueous-based coating composition reduces the corrosion of a metal substrate caused by exposure to corrosive environments when the coating composition is applied thereto. An “aqueous-based coating composition” means any aqueous-based coating composition that is applied to a metal substrate, including, but not limited to, aqueous-based coating compositions applied to a metal substrate for the sole purpose of reducing corrosion thereof, aqueous-based coating compositions applied to a metal substrate as a pre-coat or base-coat prior to the application of a second coating composition thereto, and aqueous-based coating compositions applied to a metal substrate to paint the metal substrate such as aqueous-based latex paints.

As used herein and in the appended claims, a “metal substrate” means any article or surface thereof that is formed of a metal, metal alloy or combination thereof, including, but not limited to iron, aluminum, an aluminum alloy, and steel. For example, the metal substrate can be a piece of industrial equipment or outdoor furniture. Examples of corrosive environments to which a metal substrate can be exposed include environments having harsh conditions such as a high humidity and/or high temperature, and environments exposed to water, acid, salt, and/or corrosive industrial pollutants.

As used herein and in the appended claims, the phrase “deposited on the surfaces of the titanium dioxide particles” means deposited directly or indirectly on the surfaces of the titanium dioxide particles, unless stated otherwise.

For example, the titanium dioxide particles can have a rutile crystalline structure or a combination of an anatase crystalline structure and a rutile crystalline structure. For example, the titanium dioxide particles can have a rutile crystalline structure. The titanium dioxide particles can be formed by the chloride or the sulfate process. For example, the titanium dioxide particles can be formed by the chloride process. For example, the titanium dioxide particles can be formed by the sulfate process. For example, the anti-corrosion pigment can be in dry powder or dry granule form.

For example, the titanium dioxide particles have at least one inorganic coating deposited on the surfaces thereof. For example, the inorganic coating(s) can be selected from the group consisting of metal oxide coatings, metal hydroxide coatings, and combinations thereof. For example, the inorganic coating(s) can be selected from the group consisting of silica coatings, alumina coatings, aluminum phosphate coatings, zirconia coatings, titania coatings, and combinations thereof. For example, the inorganic coating(s) can be selected from the group of silica coatings, alumina coatings, zirconia coatings, and combinations thereof

The inorganic coating(s) can be used to impart one or more properties and/or characteristics to the titanium dioxide particles to make the particles more suitable for the specific aqueous-based coating composition to which the anti-corrosion pigment is to be added. For example, the inorganic coating(s) can be used to help improve the wetting and dispersing properties of the pigment particles as well as the opacity, light stability and durability of the pigment.

For example, the inorganic coating(s) can be deposited on the surfaces of the titanium dioxide particles in an amount in the range of about 0.5% by weight to about 15% by weight, based on the combined weight of the titanium dioxide particles and the inorganic coating(s). For example, the inorganic coating(s) can be deposited on the surfaces of the titanium dioxide particles in an amount in the range of about 1% by weight to about 10% by weight, based on the combined weight of the titanium dioxide particles and the inorganic coating(s).

As used herein and in the appended claims, a “non-volatile hydroxyl amine” means a hydroxyl amine that has a boiling point of at least 250° C. The “non-volatility” of the hydroxyl amine allows the hydroxyl amine to remain stable when deposited on the surfaces of the titanium dioxide particles.

As stated above, the anti-corrosion pigment comprises in the range of from about 0.05% by weight to about 1% by weight, based on the total weight of the pigment, of at least one non-volatile, organic hydroxyl amine deposited on the surfaces of the titanium dioxide particles. For example, the anti-corrosion pigment can comprise in the range of from about 0.1% by weight to about 0.8% by weight, based on the total weight of the pigment, of at least one non-volatile, organic hydroxyl amine deposited on the surfaces of the titanium dioxide particles. For example, the anti-corrosion pigment can comprise in the range of from about 0.1% by weight to about 0.6% by weight, based on the total weight of the pigment, of at least one non-volatile, organic hydroxyl amine deposited on the surfaces of the titanium dioxide particles.

For example, the non-volatile organic hydroxyl amine can be selected from the group consisting of alkyl amine hydroxyls, aromatic amine hydroxyls, and combinations thereof. For example, the non-volatile organic hydroxyl amine is selected from the group consisting of 2-amino-2-methyl-1,3-propanediol, 2-amino-2-ethyl-1,3-propanediol, tris(hydroxymethyl)-aminomethane, triethanolamine, triisopropanolamine, N-butyl-diethanolamine, dimethylglucamine, and combinations thereof. An example of a dimethylglucamine that is suitable for use as or as part of the non-volatile organic hydroxyl amine is sold by Clariant Corporation in association with the trademark Genamin® Gluco 50.

As stated above, the anti-corrosion pigment comprises in the range of from about 0.02% by weight to about 1% by weight, based on the total weight of the pigment, of at least one organic dispersant deposited on the surfaces of the titanium dioxide particles. For example, the anti-corrosion pigment can comprise in the range of from about 0.04% by weight to about 0.8% by weight, based on the total weight of the pigment, of at least one organic dispersant deposited on the surfaces of the titanium dioxide particles. For example, the anti-corrosion pigment can comprise in the range of from about 0.04% by weight to about 0.6% by weight, based on the total weight of the pigment, of at least one organic dispersant deposited on the surfaces of the titanium dioxide particles.

As used herein and in the appended claims, a “low molecular weight organic dispersant” means an organic dispersant that has a molecular weight no greater than 1000. The “molecular weight” of a compound means the number average molecular weight of the compound. The low molecular weight organic dispersant molecules that contain one or more functional groups can be polymeric molecules, non-polymeric molecules and combinations thereof. For example, the low molecular weight organic dispersant molecules that contain one or more functional groups are polymeric molecules. For example, the low molecular weight organic dispersant molecules that contain one or more functional groups are non-polymeric molecules.

For example, the phosphonic acids and salts of phosphonic acids of the group of compounds from which the functional groups of the low molecular weight organic dispersants are derived can be selected from the group consisting of 1-hydroxyethane 1,1-diphosphonic acid, amino tris(methylene phosphonic acid), ethylenediamine tetra(methylene phosphonic acid), diethylenetriamine penta(methylene phosphonic acid), salts of such compounds, and mixtures thereof. For example, the phosphoric acids and salts of phosphoric acids of the group of compounds from which the functional groups of the low molecular weight organic dispersants are derived can be selected from the group consisting of phosphate esters and coesters of alcohols, phosphate esters and coesters of alcohol ethoxylates, salts of such compounds, and mixtures thereof. For example, the phosphonate-based carboxylic acids and salts of phosphonate-based carboxylic acids of the group of compounds from which the functional groups of the low molecular weight organic dispersants are derived can be selected from the group consisting of phosphonate-based tricarboxylic acids, salts of such compounds, and mixtures thereof. For example, the phosphonate-based carboxylic acids and salts of phosphonate-based carboxylic acids of the group of compounds from which the functional groups of the low molecular weight organic dispersants are derived can be selected from the group consisting of 2-phosphonobutane-1,2,4-tricarboxylic acid, salts of such compounds, and mixtures thereof.

As used herein and in the appended claims, the term “polymer” means a chemical compound or mixture of compounds formed by polymerization and having repeating subunits (also referred to as monomers). Unless stated otherwise, the term “polymer” includes and encompasses homopolymers, copolymers, terpolymers and the like. The term “copolymer” means a chemical compound or mixture of compounds formed by polymerization and having two or more different types of subunits (also referred to as monomers) that are linked to form a polymer chain.

For example, the polymeric molecules that contain one or more functional groups derived from compounds selected from the group consisting of phosphonic acids, phosphoric acids, phosphonate-based carboxylic acids, salts of such compounds, and combinations thereof can be selected from the group of polyacrylic acid, polyacrylic acid copolymers, salts of polyacrylic acid and polyacrylic acid copolymers, maleic acid copolymers, salts of maleic acid copolymers, and combinations thereof. For example, a suitable polymeric molecule that contains one or more functional groups derived from compounds selected from the group consisting of phosphonic acids, phosphoric acids, phosphonate-based carboxylic acids, salts of such compounds, and combinations thereof is a sulfonated styrene/maleic anhydride copolymer.

For example, the phosphonic acids of the group of compounds from which the functional groups of the polymeric molecules are derived can be monomers of organic phosphonic acids containing at least one carbon-carbon double bond, salts of such compounds and mixtures thereof. For example, the phosphoric acids of the group of compounds from which the functional groups of the polymeric molecules are derived can be monomers of phosphate esters and coesters of alcohols containing at least one carbon-carbon double bond, phosphate esters and coesters of alcohol ethoxylates containing at least one carbon-carbon double bond, salts of such compounds, and mixtures thereof.

For example, in one embodiment, the anti-corrosion pigment further comprises in the range of from about 0.001% by weight to about 1% by weight, based on the total weight of the pigment, of at least one polyhydric alcohol deposited on the surfaces of the titanium dioxide particles. As used herein and in the appended claims, a polyhydric alcohol component means an organic compound containing two or more hydroxy (—OH) groups.

For example, the anti-corrosion pigment can further comprise in the range of from about 0.05% by weight to about 0.8% by weight, based on the total weight of the pigment, of at least one polyhydric alcohol deposited on the surfaces of the titanium dioxide particles. For example, the anti-corrosion pigment can further comprise in the range of from about 0.05% by weight to about 0.6% by weight, based on the total weight of the pigment, of at least one polyhydric alcohol deposited on the surfaces of the titanium dioxide particles. For example, the anti-corrosion pigment can further comprise in the range of from about 0.1% by weight to about 0.6% by weight, based on the total weight of the pigment, of at least one polyhydric alcohol deposited on the surfaces of the titanium dioxide particles.

For example, the polyhydric alcohol(s) can be selected from the group consisting of alkyl straight chain polyols, alkyl branched chain polyols, and combinations thereof. For example, the polyhydric alcohol(s) can be selected from the group consisting of trimethylolpropane, ditrimethylolpropane, glycerol, diglycerol, pentaerythritol, mannitol, and combinations thereof. For example, the polyhydric alcohol(s) can be glycerol.

For example, as shown by the examples set forth below, when added to an aqueous-based coating composition, the anti-corrosion pigment disclosed herein can effectively reduce the corrosion of a metal substrate caused by exposure to corrosive environments when the coating composition is applied thereto. The anti-corrosion pigment also imparts hiding power to aqueous-based coating composition, which is particularly useful in connection with latex paint formulations.

The aqueous-based coating composition disclosed herein comprises an aqueous mixture, and an anti-corrosion pigment dispersed in the aqueous mixture. The anti-corrosion pigment used to form the aqueous-based coating composition is the anti-corrosion pigment disclosed herein and described above. For example, the anti-corrosion pigment is in dry form prior to being dispersed in the aqueous mixture.

For example, the aqueous mixture can include water, a surfactant and a dispersant. For example, the aqueous mixture can be a latex resin aqueous mixture.

As set forth above, as used herein and in the appended claims, an “aqueous-based coating composition” means any aqueous-based coating composition that is applied to a metal substrate, including, but not limited to, aqueous-based coating compositions applied to a metal substrate for the sole purpose of reducing corrosion thereof, aqueous-based coating compositions applied to a metal substrate as a pre-coat or base-coat prior to the application of a second coating composition thereto, and aqueous-based coating compositions applied to a metal substrate to paint the metal substrate such as aqueous-based latex paints. For example, the aqueous-based coating composition can be a latex paint formulation.

As set forth above, as used herein and in the appended claims, a “metal substrate” means any article or surface thereof that is formed of a metal, metal alloy or combination thereof, including, but not limited to iron, aluminum, an aluminum alloy, and steel. For example, the metal substrate can be a piece of industrial equipment or outdoor furniture. Examples of corrosive environments to which a metal substrate can be exposed include environments having harsh conditions such as a high humidity and/or high temperature, environments exposed to water, acid, salt, and/or corrosive industrial pollutants.

The method of forming a dry anti-corrosion pigment for use in an aqueous-based coating composition disclosed herein comprises providing a plurality of titanium dioxide particles; providing at least one non-volatile, organic hydroxyl amine; providing at least one organic dispersant; depositing the non-volatile, organic hydroxyl amine(s) on the surfaces of the titanium dioxide particles in an amount in the range of from about 0.05% by weight to about 1% by weight, based on the total weight of the pigment; depositing the organic dispersant(s) on the surfaces of the titanium dioxide particles in an amount in the range of from about 0.02% by weight to about 1% by weight, based on the total weight of the pigment; and drying the titanium dioxide particles having the non-volatile, organic hydroxyl amine(s) and the organic dispersant(s); thereon to form the dry anti-corrosion pigment. The titanium dioxide particles, non-volatile, organic hydroxyl amine(s), and organic dispersant(s) are the same as the titanium dioxide particles, non-volatile, organic hydroxyl amine(s), and organic dispersant(s) described above in connection with the dry anti-corrosion pigment described above and disclosed herein. Similarly, the anti-corrosion pigment formed by the method is the anti-corrosion pigment disclosed herein and described above.

For example, the titanium dioxide particles can be raw titanium dioxide particles, and the method can further comprise:

prior to depositing the non-volatile, organic hydroxyl amine and the organic dispersant on the surfaces of the raw titanium dioxide particles, grinding the titanium dioxide particles to a desired particle size and filtering and washing the ground titanium dioxide particles to form a wet pigment filter cake;

wherein the non-volatile, organic hydroxyl amine and the organic dispersant are deposited on the surfaces of the titanium dioxide particles by mixing the dispersant package with the wet pigment filter cake.

The raw titanium dioxide particles can be coated with an inorganic coating (for example, a silica, alumina and/or zirconia coating) prior to being ground.

For example, the method can further comprise:

drying the wet pigment filter cake to form a dried pigment filter cake;

crushing the dried pigment filter cake to form a crushed pigment filter cake; and

steam micronizing the crushed filter cake to form the anti-corrosion pigment.

For example, in one embodiment, the method of forming a dry anti-corrosion pigment for use in an aqueous-based coating composition disclosed herein further comprises providing a at least one polyhydric alcohol; and depositing the polyhydric alcohol(s) on the surfaces of the titanium dioxide particles in an amount in the range of from about 0.001% by weight to about 1% by weight, based on the total weight of the pigment. In this embodiment, the titanium dioxide particles that are dried having the non-volatile, organic hydroxyl amine(s), the organic dispersant(s) and the polyhydric alcohol(s) deposited thereon. The organic hydroxyl amine(s) is the same as the organic hydroxyl amine(s) described above in connection with the dry anti-corrosion pigment described above and disclosed herein. Similarly, the anti-corrosion pigment formed by the method is the anti-corrosion pigment disclosed herein and described above.

The method of forming an aqueous-based coating composition disclosed herein comprises providing an aqueous mixture; providing an anti-corrosion pigment, wherein the anti-corrosive pigment is in dry form; and dispersing the anti-corrosive pigment in the aqueous mixture.

For example, the aqueous mixture used in the method can include water, a surfactant and a dispersant. For example, the aqueous mixture used in the method can be a latex resin aqueous mixture.

The anti-corrosion pigment used in the method is the same as the anti-corrosion pigment described above and disclosed herein. The aqueous-based coating composition formed by the method is the aqueous-based coating composition described above and disclosed herein.

For example, in one embodiment, an anti-corrosion pigment for an aqueous-based coating composition is provided. In this embodiment, the anti-corrosion pigment comprises: a plurality of titanium dioxide particles; in the range of from about 0.05% by weight to about 1% by weight, based on the total weight of the pigment, of at least one non-volatile, organic hydroxyl amine deposited on the surfaces of the titanium dioxide particles; in the range of from about 0.02% by weight to about 1% by weight, based on the total weight of the pigment, of at least one organic dispersant deposited on the surfaces of the titanium dioxide particles; and in the range of from about 0.001% by weight to about 1% by weight, based on the total weight of the pigment, of at least one polyhydric alcohol deposited on the surfaces of the titanium dioxide particles. The organic dispersant(s) is selected from the group consisting of low molecular weight organic dispersants, organic polymeric dispersants, and combinations thereof. The low molecular weight organic dispersants are molecules that contain one or more functional groups derived from compounds selected from the group consisting of phosphonic acids, phosphoric acids, phosphonate-based carboxylic acids, salts of such compounds, and combinations thereof. The organic polymeric dispersants are polymeric molecules that contain one or more functional groups derived from compounds selected from the group consisting of phosphonic acids, phosphoric acids, phosphonate-based carboxylic acids, salts of such compounds, and combinations thereof. The pigment is in dry form.

For example, in another embodiment, an aqueous-based coating composition is provided. In this embodiment, the aqueous-based coating composition comprises an aqueous mixture; and an anti-corrosion pigment dispersed in the aqueous mixture. The anti-corrosion pigment comprises a plurality of titanium dioxide particles; in the range of from about 0.05% by weight to about 1% by weight, based on the total weight of the pigment, of at least one non-volatile, organic hydroxyl amine deposited on the surfaces of the titanium dioxide particles; in the range of from about 0.02% by weight to about 1% by weight, based on the total weight of the pigment, of at least one organic dispersant deposited on the surfaces of the titanium dioxide particles; and in the range of from about 0.001% by weight to about 1% by weight, based on the total weight of the pigment, of at least one polyhydric alcohol deposited on the surfaces of the titanium dioxide particles. The organic dispersant(s) is selected from the group consisting of low molecular weight dispersants, organic polymeric dispersants, and combinations thereof. The low molecular weight organic dispersants are molecules that contain one or more functional groups derived from compounds selected from the group consisting of phosphonic acids, phosphoric acids, phosphonate-based carboxylic acids, salts of such compounds, and combinations thereof. The organic polymeric dispersants are polymeric molecules that contain one or more functional groups derived from compounds selected from the group consisting of phosphonic acids, phosphoric acids, phosphonate-based carboxylic acids, salts of such compounds, and combinations thereof. The pigment is in dry form.

In yet another embodiment, a method of forming a dry anti-corrosion pigment for use in an aqueous-based coating composition is provided. In this embodiment, the dry anti-corrosion pigment for use in an aqueous-based coating composition comprises: providing a plurality of titanium dioxide particles; providing at least on non-volatile, organic hydroxyl amine; providing at least one organic dispersant; providing at least one polyhydric alcohol; depositing the non-volatile, organic hydroxyl amine(s) on the surfaces of the titanium dioxide particles in an amount in the range of from about 0.05% by weight to about 1% by weight, based on the total weight of the pigment; depositing the organic dispersant(s) on the surfaces of the titanium dioxide particles in an amount in the range of from about 0.02% by weight to about 1% by weight, based on the total weight of the pigment; depositing the polyhydric alcohol(s) on the surfaces of the titanium dioxide particles in an amount in the range of from about 0.001% by weight to about 1% by weight, based on the total weight of the pigment; and drying the titanium dioxide particles having the non-volatile, organic hydroxyl amine(s), the organic dispersant(s) and the polyhydric alcohol(s) deposited thereon to form the dry anti-corrosion pigment. The organic dispersant(s) is selected from the group consisting of low molecular weight organic dispersants, organic polymeric dispersants, and combinations thereof, The low molecular weight organic dispersants are molecules that contain one or more functional groups derived from compounds selected from the group consisting of phosphonic acids, phosphoric acids, phosphonate-based carboxylic acids, salts of such compounds, and combinations thereof. The organic polymeric dispersants are polymeric molecules that contain one or more functional groups derived from compounds selected from the group consisting of phosphonic acids, phosphoric acids, phosphonate-based carboxylic acids, salts of such compounds, and combinations thereof. The pigment formed by the method is in dry form.

In yet another embodiment, a method of forming an aqueous-based coating composition is provided. In this embodiment, the method of forming an aqueous-based coating composition comprises: providing an aqueous mixture; providing an anti-corrosion pigment, wherein the anti-corrosive pigment is in dry form; and dispersing the anti-corrosive pigment in the aqueous solution. The anti-corrosive pigment includes: a plurality of titanium dioxide particles; in the range of from about 0.05% by weight to about 1% by weight, based on the total weight of the pigment, of at least one non-volatile, organic hydroxyl amine deposited on the surfaces of the titanium dioxide particles; in the range of from about 0.02% by weight to about 1% by weight, based on the total weight of the pigment, of at least one organic dispersant deposited on the surfaces of the titanium dioxide particles; and in the range of from about 0.001% by weight to about 1% by weight, based on the total weight of the pigment, of at least one polyhydric alcohol deposited on the surfaces of the titanium dioxide particles. The organic dispersant is selected from the group consisting of low molecular weight organic dispersants, organic polymeric dispersants, and combinations thereof. The low molecular weight organic dispersants are molecules that contain one or more functional groups derived from compounds selected from the group consisting of phosphonic acids, phosphoric acids, phosphonate-based carboxylic acids, salts of such compounds, and combinations thereof. The organic polymeric dispersants are polymeric molecules that contain one or more functional groups derived from compounds selected from the group consisting of phosphonic acids, phosphoric acids, phosphonate-based carboxylic acids, salts of such compounds, and combinations thereof.

The following illustrative examples illustrate specific embodiments consistent with the present disclosure but do not limit the scope of the disclosure or the appended claims. Concentrations and percentages are by weight unless otherwise indicated.

### ILLUSTRATIVE EXAMPLES

### Example 1—Preparation of Silica and Alumina-Treated Titanium Dioxide Filter Cake

Particulate titanium dioxide pigment particles formed by the chloride process containing 1.0% alumina in its crystalline lattice were dispersed in water in the presence of 0.075% of sodium hexametaphosphate dispersant, along with a sufficient amount of sodium hydroxide to adjust the pH of the dispersion to 9.5 or higher to achieve an aqueous dispersion with a solids content of 35%. The resulted slurry was subjected to sanding milling (using a zircon sand-to-pigment weight ratio of 4:1) until 94% of the titanium dioxide particles had a particle size smaller than 0.63 microns, as determined by a Microtrac X 100 Particle Size Analyzer.

The resulting slurry, diluted to a 30% solids content, was heated to 75° C. and subsequently treated with 3.0% by weight of sodium silicate (calculated as silica by weight of the final pigment). The sodium silicate was added over 20 minutes. While maintaining the temperature at 75° C., the pH of the slurry was slowly decreased to a pH of 5.5 over a 55 minute period via the slow addition of concentrated sulfuric acid. After allowing the slurry to digest for 15 minutes, 1.6% by weight of sodium aluminate (calculated as alumina by weight of the final pigment), was added to the slurry over 10 minutes. The pH of the slurry was maintained between 8.25 and 9.25 via the concomitant addition of concentrated sulfuric acid. The slurry was allowed to digest for 15 minutes at 75° C. The pH of the slurry was then adjusted to 6.2 with concentrated sulfuric acid. The slurry was filtered while hot. The resulting filtrate was washed with water, which had been preheated to 60 C. A wet titanium dioxide filter cake with the titanium dioxide particles having silica and aluminum coatings on the surfaces thereof was obtained.

### Example 2—Preparation of Control Titanium Dioxide Pigment

The wet titanium dioxide filter cake from Example 1 was weighted in a stainless steel pot to have a weight that was equivalent to 1000 g dry pigment. Deionized water was added to the filter cake to form a pigment slurry. Next, 10.61 g of a 33% trimethylolpropane aqueous solution was added to the slurry and mixed well therein. The treated Titanium dioxide slurry was then spray dried, and a dried pigment was obtained. The dried pigment was then steam micronized utilizing a steam to pigment weight ratio of 2.5:1 with a steam injector pressure set at 160 psi and micronizer ring pressure set at 118 psi.

### Example 3—Preparation of the Anti-Corrosion Titanium Dioxide Pigment Disclosed Herein

The wet titanium dioxide filter cake from Example 1 was weighted in a stainless steel pot to have a weight that was equivalent to 1000 g dry pigment. A chemical mixture was prepared with 10.61 g of a 33% trimethylolpropane aqueous solution, 2.0 g of glycerol, 4.0 g of tris(hydroxymethyl)aminomethane (TRIS), 1.75 g of a 40% 2-phosphonobutane-1,2,4-tricarboxylic acid tetrasodium salt aqueous solution, and 1.48 g of Pat-Add 603 (a polymeric dispersant form Patcham Ltd.).

The chemical mixture was then mixed with the filter cake. The filter cake was fluidized to form a slurry without extra water. The treated Titanium dioxide slurry was then spray dried to obtain a dried pigment. The dried pigment was then steam micronized utilizing a steam to pigment weight ratio of 2.5:1 with a steam injector pressure set at 160 psi and micronizer ring pressure set at 118 psi.

### Example 4—Preparation of the Anti-Corrosion Titanium Dioxide Pigment Disclosed Herein

The wet titanium dioxide filter cake from Example 1 was weighted in a stainless steel pot to have a weight that was equivalent to 1000 g dry pigment. A chemical mixture was prepared with 10.61 g of a 33% trimethylolpropane aqueous solution, 2.0 g of glycerol, 5.0 g of triethanolamine, 1.75 g of a 40% 2-phosphonobutane-1,2,4-tricarboxylic acid tetrasodium salt aqueous solution, and 1.48 g of Pat-Add 603 (a polymeric dispersant form Patcham Ltd.).

The chemical mixture was then mixed with the filter cake. The filter cake was fluidized to form a slurry without extra water. The treated Titanium dioxide slurry was then spray dried to obtain a dried pigment. The dried pigment was then steam micronized utilizing a steam to pigment weight ratio of 2.5:1 with a steam injector pressure set at 160 psi and micronizer ring pressure set at 118 psi.

### Example 5—Preparation of the Anti-Corrosion Titanium Dioxide Pigment Disclosed Herein

The wet titanium dioxide filter cake from Example 1 was weighted in a stainless steel pot to have a weight that was equivalent to 1000 g dry pigment. A chemical mixture was prepared with 10.61 g of a 33% trimethylolpropane aqueous solution, 2.0 g of glycerol, 6.0 g of triisopropanolamine, 1.75 g of a 40% 2-phosphonobutane-1,2,4-tricarboxylic acid tetrasodium salt aqueous solution, and 1.48 g of Pat-Add 603 (a polymeric dispersant form Patcham Ltd.).

The chemical mixture was then mixed with the filter cake. The filter cake was fluidized to form a slurry without extra water. The treated Titanium dioxide slurry was then spray dried to obtain a dried pigment. The dried pigment was then steam micronized utilizing a steam to pigment weight ratio of 2.5:1 with a steam injector pressure set at 160 psi and micronizer ring pressure set at 118 psi.

### Example 6—Preparation of Titanium Dioxide Slurries

### 6a. Slurry Preparation for Control Titanium Dioxide Pigment of Example 2:

The control titanium dioxide pigment of Example 2 was wetted in deionized water with a hydrophilic acrylic acid-based copolymer dispersant and a hydroxyl amine based co-dispersant. The wetted pigment was then ground at high speed with a Cowles blade for 10 minutes. The solids content of the slurry was adjusted to 76.5%.

### 6b. Slurry Preparation of Anti-corrosion Titanium Dioxide pigments of Example 3-5

For each of the anti-corrosion titanium dioxide pigments of Examples 3-5, approximately 300 g of the pigment were added to 92.2 g of deionized water and stirred with a propeller blade. The solids content of each resulting slurry was 76.5%.

### Example 7—Testing of Titanium Dioxide Pigment Slurries of Example 6

Each of the titanium dioxide pigment slurries prepared in Example 6 was used to prepare a direct-to-metal (DTM) anti-corrosion gloss latex coating. The formulation of each coating is shown in Table 1 below.

“Avanse 200” is a DTM latex resin from Dow Chemical.

“Tamol 165A” is a hydrophobic dispersant from Dow Chemical.

Surfynol “CT-111” is a multi-purpose surfactant from Evonik.

“BYK-24” is a defoamer from BYK Chemie.

“Texanol” is a coalescent from Eastman.

“Acrysol RM-2020 NPR” and “Acrysol RM-8W” are rheology modifiers from Dow Chemical.

“Proxel GXL” is a BIT-based biocide from Lonza.

The referenced ammonia solution is a pH adjuster, and the referenced sodium nitrite is a flash rust inhibitor.

TABLE 1
Waterborne DTM gloss latex coating formulation

| | Weight |
|---|---|
| Materials | (g) |
| Avanse 200 | 500.0 |
| 76.5% TiO₂ slurry | 326.8 |
| Tamol 165A | 5.0 |
| Surfynol CT-111 | 1.0 |
| Ammonia (28%) | 1.6 |
| BYK-24 | 2.0 |
| Sodium nitrite | 1.0 |
| Texanol | 33.8 |
| Acrysol RM-2020 NPR | 10.0 |
| Acrysol Rm-8W | 4.3 |
| Proxel GXL | 1.0 |
| water | 174.2 |
| Totals | 1060.7 |

The obtained coatings were applied on 4-inch by 6-inch steel Q-panels for corrosion testing. The steel panels were degreased with acetone twice. A 3-inch bird drawdown bar with a 6 mil gap was used to cast the coating film on the degreased steel panels. After the coated panels dried under ambient condition for a week, the exposed bare metal was covered with duct tape and then a X-shape cross was cut through the coating film with a knife. The coated panels were then subjected to 600 hours of continuous salt spray testing (ASTM B117 method).

A commercial DTM gloss latex coating from a major national coating company was tested in the same manner for use as a reference.

Upon observation of the steel panels for rust, it was clear that the DTM coatings made with the anti-corrosion pigment of Examples 3, 4 and 5, 3-5, the anti-corrosion pigment disclosed herein, were much better in corrosion resistance than the control pigment of Example 2 and the commercial DTM gloss latex coating.

### Example 8—Testing of Titanium Dioxide Pigment Slurries

The control titanium dioxide pigment of Example 2 and the anti-corrosion titainium dioxide pigment of Example 3 were used to prepare a direct-to-metal (DTM) anti-corrosion semi-gloss latex coatings. The formulation of each coating is shown in Table 3 below.

“Tamol 165A” is a hydrophobic dispersant from Dow Chemical.

“Surfynol CT-111” is a multi-purpose surfactant from Evonik.

“Tego 810” is a defoamer from Evonik.

“Minex 7” is an extender from Unimin.

“Avanse 200” is a DTM latex resin from Dow Chemical.

“BYK-24” is a defoamer from BYK Chemie.

“Texanol” is a coalescent from Eastman.

“Acrysol RM-2020 NPR” and “Acrysol RM-8W” are rheology modifiers from Dow Chemical.

“Proxel GXL” is a BIT-based biocide from Lonza.

The referenced ammonia solution is a pH adjuster, and the referenced sodium nitrite is a flash rust inhibitor.

TABLE 2
Waterborne DTM semi-gloss latex paint formulation.

| Materials | Weight (g) |
|---|---|
| Grinding | |
| Water | 135.0 |
| Tamol 165A | 12.0 |
| Surfynol CT-111 | 2.0 |
| Tego 810 | 1.0 |
| TiO₂ dry pigment | 250.0 |
| Minex 7 | 50.0 |
| Letdown | |
| Avanse 200 | 490.0 |
| Ammonia (28%) | 1.6 |
| BYK-24 | 2.0 |
| Sodium nitrite | 1.0 |
| Texanol | 33.1 |
| Acrysol RM-2020 NPR | 10.0 |
| Acrysol RM-8W | 3.0 |
| Proxel GXL | 1.0 |
| water | 95.0 |
| Totals | 1086.7 |

The obtained coatings were applied on 4-inch by 6-inch steel Q-panels for corrosion testing. The steel panels were degreased with acetone twice. A 3-inch bird drawdown bar with a 6 mil gap was used to cast the coating film on the degreased steel panels. After the coated panels dried under ambient condition for a week, the exposed bare metal was covered with duct tape and then a X-shape cross was cut through the coating film with a knife. The coated panels were then subjected to 600 hours of continuous salt spray testing (ASTM B 117 method).

Two commercial DTM semi-gloss latex paints from major national coating companies were tested in the same manner for use as references.

Upon observation of the steel panels for rust, it was clear that the DTM coatings made with the anti-corrosion pigment of Examples 3, the anti-corrosion pigment disclosed herein, was much better in corrosion resistance than the control pigment of Example 2 and the commercial DTM gloss latex coating references.

### Example 9—Preparation of Titanium Dioxide Control Pigment Slurries

The wet titanium dioxide filter cake from Example 1 was weighted in a stainless steel pot to have a weight that was equivalent to 1000 g dry pigment. Deionized water was added to the filter cake to form a titanium dioxide slurry.

Approximately 3.5 g of trimethylolpropane and 4.0 g of tris(hydroxymethyl)aminomethane were dissolved in 15 g water to form a chemical solution. The chemical mixture was then mixed into the titanium dioxide slurry. The treated titanium dioxide slurry was then spray dried to obtain a dried pigment. The dried pigment was then steam micronized utilizing a steam to pigment weight ratio of 2.5:1 with a steam injector pressure set at 160 psi and micronizer ring pressure set at 118 psi.

### Example 10—Preparation of Titanium Dioxide Control Pigment Slurries

The wet titanium dioxide filter cake from Example 1 was weighted in a stainless steel pot to have a weight that was equivalent to 1000 g dry pigment. Deionized water was added to the filter cake to form a titanium dioxide slurry.

A chemical mixture was prepared with 10.61 g of a 33% trimethylolpropane aqueous solution and 1.75 g of a 40% 2-phosphonobutane-1,2,4-tricarboxylic acid tetrasodium salt aqueous solution.

The chemical mixture was then mixed into the titanium dioxide slurry. The treated titanium dioxide slurry was then spray dried to obtain a dried pigment. The dried pigment was then steam micronized utilizing a steam to pigment weight ratio of 2.5:1 with a steam injector pressure set at 160 psi and micronizer ring pressure set at 118 psi.

### Example 11—Preparation of the Anti-Corrosion Titanium Dioxide Pigment Disclosed Herein

The wet titanium dioxide filter cake from Example 1 was weighted in a stainless steel pot to have a weight that was equivalent to 1000 g dry pigment. A chemical mixture was prepared with 10.61 g of a 33% trimethylolpropane aqueous solution, 2.0 g of glycerol, 1.0 g of tris(hydroxymethyl)aminomethane, 1.75 g of a 40% 2-phosphonobutane-1,2,4-tricarboxylic acid tetrasodium salt aqueous solution, and 1.48 g of Pat-Add 603 (a polymeric dispersant form Patcham Ltd.).

The chemical mixture was then mixed with the filter cake. The filter cake was fluidized to form a slurry without extra water. The treated Titanium dioxide slurry was then spray dried to obtain a dried pigment. The dried pigment was then steam micronized utilizing a steam to pigment weight ratio of 2.5:1 with a steam injector pressure set at 160 psi and micronizer ring pressure set at 118 psi.

### Example 12—Preparation of the Anti-Corrosion Titanium Dioxide Pigment Disclosed Herein

The wet titanium dioxide filter cake from Example 1 was weighted in a stainless steel pot to have a weight that was equivalent to 1000 g dry pigment. A chemical mixture was prepared with 10.61 g of a 33% trimethylolpropane aqueous solution, 2.0 g of glycerol, 8.0 g of tris(hydroxymethyl)aminomethane, 1.75 g of a 40% 2-phosphonobutane-1,2,4-tricarboxylic acid tetrasodium salt aqueous solution, and 1.48 g of Pat-Add 603 (a polymeric dispersant form Patcham Ltd.).

The chemical mixture was then mixed with the filter cake. The filter cake was fluidized to form a slurry without extra water. The treated Titanium dioxide slurry was then spray dried to obtain a dried pigment. The dried pigment was then steam micronized utilizing a steam to pigment weight ratio of 2.5:1 with a steam injector pressure set at 160 psi and micronizer ring pressure set at 118 psi.

### Example 13—Preparation of the Anti-corrosion Titanium Dioxide Pigment Disclosed Herein

The wet titanium dioxide filter cake from Example 1 was weighted in a stainless steel pot to have a weight that was equivalent to 1000 g dry pigment. A chemical mixture was prepared with 10.61 g of a 33% trimethylolpropane aqueous solution, 2.0 g of glycerol, 8.0 g of tris(hydroxymethyl)aminomethane, 3.75 g of a 40% 2-phosphonobutane-1,2,4-tricarboxylic acid tetrasodium salt aqueous solution, and 1.48 g of Pat-Add 603 (a polymeric dispersant form Patcham Ltd.).

The chemical mixture was then mixed with the filter cake. The filter cake was fluidized to form a slurry without extra water. The treated Titanium dioxide slurry was then spray dried to obtain a dried pigment. The dried pigment was then steam micronized utilizing a steam to pigment weight ratio of 2.5:1 with a steam injector pressure set at 160 psi and micronizer ring pressure set at 118 psi.

### Example 14—Preparation of Zirconia and Alumina-treated Titanium Dioxide Filter Cake

Particulate titanium dioxide pigment particles formed by the chloride process containing 0.8% alumina in its crystalline lattice were dispersed in water to form a slurry. The resulting slurry was subjected to sanding milling (using a zircon sand-to-pigment weight ratio of 4:1) until 92% of the titanium dioxide particles had a particle size smaller than 0.63 microns, as determined by a Microtrac X 100 Particle Size Analyzer.

The resulting slurry, diluted to a 30% solids content, was heated to 65° C. and subsequently treated with 0.3% by weight of sodium hexametaphosphate (calculated as phosphorous pentoxide by weight of the final pigment). The sodium hexametaphosphate was added over 20 minutes. Next, 0.3% by weight of zirconium oxychloride (calculated as zirconia by weight of the final pigment), was added to the slurry over 10 minutes. Next, 2.0% by weight of sodium aluminate (calculated as alumina by weight of the final pigment), was added to the slurry over 10 minutes. The pH of the slurry was maintained at a level lower than 11.0. The slurry was allowed to digest for 15 minutes at 65° C. The pH of the slurry was then adjusted to 6.3 with hydrochloric acid. The slurry was filtered while hot. The resulting filtrate was washed with water, which had been preheated to 60 C. A wet titanium dioxide filter cake with the titanium dioxide particles having zirconia and alumina coatings on the surfaces thereof was obtained.

### Example 15—Preparation of Control Titanium Dioxide Pigment

The wet titanium dioxide filter cake from Example 14 was weighted in a stainless steel pot to have a weight that was equivalent to 1000 g dry pigment. Deionized water was added to the filter cake to form a pigment slurry. Next, 10.61 g of a 33% trimethylolpropane aqueous solution was added to the slurry and mixed well therein. The treated Titanium dioxide slurry was then spray dried, and a dried pigment was obtained. The dried pigment was then steam micronized utilizing a steam to pigment weight ratio of 2.5:1 with a steam injector pressure set at 160 psi and micronizer ring pressure set at 118 psi.

### Example 16—Preparation of the Anti-corrosion Titanium Dioxide Pigment Disclosed Herein

The wet titanium dioxide filter cake from Example 14 was weighted in a stainless steel pot to have a weight that was equivalent to 1000 g dry pigment. A chemical mixture was prepared with 1.0 g potassium carbonate, 10.61 g of a 33% trimethylolpropane aqueous solution, 2.0 g of glycerol, 4.0 g of tris(hydroxymethyl)aminomethane, 3.5 g of a 40% 2-phosphonobutane-1,2,4-tricarboxylic acid tetrasodium salt aqueous solution, and 1.48 g of Pat-Add 603 (a polymeric dispersant form Patcham Ltd.).

The chemical mixture was then mixed with the filter cake. The filter cake was fluidized to form a slurry without extra water. The treated Titanium dioxide slurry was then spray dried to obtain a dried pigment. The dried pigment was then steam micronized utilizing a steam to pigment weight ratio of 2.5:1 with a steam injector pressure set at 160 psi and micronizer ring pressure set at 118 psi.

### Example 17—Testing of Titanium Dioxide Pigment Slurries

The control titanium dioxide pigment of Examples 2, 9, 10 and 15, and the anti-corrosion titainium dioxide pigments of Examples 11-13 and 16, were used to prepare a direct-to-metal (DTM) anti-corrosion semi-gloss latex coatings. The formulation of each coating is shown in Table 3 below.

“Tamol 165A” is a hydrophobic dispersant from Dow Chemical.

“Surfynol CT-111” is a multi-purpose surfactant from Evonik.

“Tego 810” is a defoamer from Evonik.

“Minex 7” is an extender from Unimin.

“Avanse 200” is a DTM latex resin from Dow Chemical.

“BYK-24” is a defoamer from BYK Chemie.

“Texanol” is a coalescent from Eastman.

“Acrysol RM-2020 NPR” and “Acrysol RM-8W” are rheology modifiers from Dow Chemical.

“Proxel GXL” is a BIT-based biocide from Lonza.

The referenced ammonia solution is a pH adjuster, and the referenced sodium nitrite is a flash rust inhibitor.

TABLE 3
Waterborne DTM gloss latex paint formulation from dry TiO₂ pigments.

| Materials | Weight (g) |
|---|---|
| Grinding | |
| Water | 120.0 |
| Tamol 165A | 10.0 |
| Surfynol CT-111 | 2.0 |
| Tego 810 | 1.0 |
| TiO2 dry pigment | 250.0 |
| Letdown | |
| Avanse 200 | 500.0 |
| Ammonia (28%) | 1.6 |
| BYK-24 | 2.0 |
| Sodium nitrite | 1.0 |
| Texanol | 33.8 |
| Acrysol RM-2020 NPR | 10.0 |
| Acrysol RM-8W | 4.3 |
| Proxel GXL | 1.0 |
| water | 125 |
| Totals | 1086.7 |

The obtained coatings were applied on 4-inch by 6-inch steel Q-panels for corrosion testing. The steel panels were degreased with acetone twice. A 3-inch bird drawdown bar with a 6 mil gap was used to cast the coating film on the degreased steel panels. After the coated panels dried under ambient condition for a week, the exposed bare metal was covered with duct tape and then a X-shape cross was cut through the coating film with a knife. The coated panels were then subjected to 600 hours of continuous salt spray testing (ASTM B 117 method).

Upon observation of the steel panels for rust, it was clear that the DTM coatings made with the anti-corrosion pigment disclosed herein (Examples 11, 12, 13 and 16) were much better in corrosion resistance than the control pigments tested (Examples 2, 9, 10 and 15).

Therefore, the pigments, compositions and methods are well adapted to attain the ends and advantages mentioned, as well as those that are inherent therein. The particular examples disclosed above are illustrative only, as the present pigments, compositions and methods may be modified and practiced in different but equivalent manners apparent to those skilled in the art having the benefit of the teachings herein. It is therefore evident that the particular illustrative examples disclosed above may be altered or modified, and all such variations are considered within the scope and spirit of the present pigments, compositions and methods. While the pigments, compositions and methods are described in terms of “comprising,” “containing,” “having,” or “including” various components or steps, the pigments, compositions and methods can also, in some examples, “consist essentially of” or “consist of” the various components and steps. Whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee.

What is claimed is:

1. An anti-corrosion pigment for an aqueous-based coating composition, comprising:
a plurality of titanium dioxide particles;
in the range of from about 0.05% by weight to about 1% by weight, based on the total weight of the pigment, of at least one non-volatile, organic hydroxyl amine deposited on the surfaces of said titanium dioxide particles; and
in the range of from about 0.02% by weight to about 1% by weight, based on the total weight of said pigment, of at least one organic dispersant deposited on the surfaces of said titanium dioxide particles, wherein said organic dispersant is selected from the group consisting of low molecular weight organic dispersants, organic polymeric dispersants, and combinations thereof, and wherein:
said low molecular weight organic dispersants are molecules that contain one or more functional groups derived from compounds selected from the group consisting of phosphonic acids, phosphoric acids, phosphonate-based carboxylic acids, salts of such compounds, and combinations thereof;
said organic polymeric dispersants are polymeric molecules that contain one or more functional groups derived from compounds selected from the group consisting of phosphonic acids, phosphoric acids, phosphonate-based carboxylic acids, salts of such compounds, and combinations thereof; and
said pigment is in dry form.

2. The anti-corrosion pigment of claim 1, wherein said titanium dioxide particles have at least one inorganic coating deposited on the surfaces thereof, wherein said inorganic coating(s) is selected from the group consisting of metal oxide coatings, metal hydroxide coatings, and combinations thereof.

3. The anti-corrosive pigment of claim 2, wherein said inorganic coating(s) are selected from the group consisting of silica coatings, alumina coatings, zirconium coatings, and combinations thereof.

4. The anti-corrosion pigment of claim 1, wherein said non-volatile organic hydroxyl amine is selected from the group consisting of alkyl amine hydroxyls, aromatic amine hydroxyls, and combinations thereof.

5. The anti-corrosion pigment of claim 4, wherein said non-volatile organic hydroxyl amine is selected from the group consisting of 2-amino-2-methyl-1,3-propanediol, 2-amino-2-ethyl-1,3-propanediol, tris(hydroxymethyl)aminomethane, triethanolamine, triisopropanolamine, N-butyl-diethanolamine, dimethylglucamine, and combinations thereof.

6. The anti-corrosion pigment of claim 1, wherein said phosphonic acids and salts of phosphonic acids of said group of compounds from which said functional groups of said low molecular weight organic dispersants are derived are selected from the group consisting of 1-hydroxyethane 1,1-diphosphonic acid, amino tris(methylene phosphonic acid), ethylenediamine tetra(methylene phosphonic acid), diethylenetriamine penta(methylene phosphonic acid), salts of such compounds, and mixtures thereof.

7. The anti-corrosion pigment of claim 1, wherein said phosphoric acids and salts of phosphoric acids of said group of compounds from which said functional groups of said low molecular weight organic dispersants are derived are selected from the group consisting of phosphate esters and coesters of alcohols, phosphate esters and coesters of alcohol ethoxylates, salts of such compounds, and mixtures thereof.

8. The anti-corrosion pigment of claim 1, wherein said phosphonate-based carboxylic acids and salts of phosphonate-based carboxylic acids of compounds from which said functional groups of said low molecular weight organic dispersants are derived are selected from the group consisting of phosphonate-based tricarboxylic acids, salts of such compounds, and mixtures thereof.

9. The anti-corrosion pigment of claim 8, wherein said phosphonate-based carboxylic acids and salts of phosphonate-based carboxylic acids of compounds from which said functional groups of said low molecular weight organic dispersants are derived are selected from the group consisting of 2-phosphonobutane-1,2,4-tricarboxylic acid, salts of such compounds, and mixtures thereof.

10. The anti-corrosion pigment of claim 1, wherein said phosphonic acids of said group of compounds from which said functional groups of said polymeric molecules are derived are monomers of organic phosphonic acids containing at least one carbon-carbon double bond, salts of such compounds and mixtures thereof.

11. The anti-corrosion pigment of claim 1, wherein said phosphoric acids of said group of compounds from which said functional groups of said polymeric molecules are derived are monomers of phosphate esters and coesters of alcohols containing at least one carbon-carbon double bond, phosphate esters and coesters of alcohol ethoxylates containing at least one carbon-carbon double bond, salts of such compounds, and mixtures thereof.

12. The anti-corrosion pigment of claim 1, further comprising in the range of from about 0.001% by weight to about 1% by weight, based on the total weight of the pigment, of at least one polyhydric alcohol deposited on the surfaces of said titanium dioxide particles.

13. The anti-corrosion pigment of claim 12, wherein said polyhydric alcohol(s) is selected from the group consisting of alkyl straight chain polyols, alkyl branched chain polyols, and combinations thereof.

14. The anti-corrosion pigment of claim 13, wherein said polyhydric alcohol(s) is selected from the group consisting of trimethylolpropane, ditrimethylolpropane, glycerol, diglycerol, pentaerythritol, mannitol, and combinations thereof.

15. An aqueous-based coating composition, comprising:
an aqueous mixture; and
an anti-corrosion pigment dispersed in said aqueous mixture, said anti-corrosive pigment including:
a plurality of titanium dioxide particles;
in the range of from about 0.05% by weight to about 1% by weight, based on the total weight of the pigment, of at least one non-volatile, organic hydroxyl amine deposited on the surfaces of said titanium dioxide particles; and
in the range of from about 0.02% by weight to about 1% by weight, based on the total weight of said pigment, of at least one organic dispersant deposited on the surfaces of said titanium dioxide particles, wherein said organic dispersant is selected from the group consisting of low molecular weight organic dispersants, organic polymeric dispersants, and combinations thereof, and wherein:
said low molecular weight organic dispersants are molecules that contain one or more functional groups derived from compounds elected from the group consisting of phosphonic acids, phosphoric acids, phosphonate-based carboxylic acids, salts of such compounds, and combinations thereof; and
said organic polymeric dispersants are polymeric molecules that contain one or more functional groups derived from compounds selected from the group consisting of phosphonic acids, phosphoric acids, phosphonate-based carboxylic acids, salts of such compounds, and combinations thereof.

16. The aqueous-based coating composition of claim 1, wherein said anti-corrosion pigment further includes in the range of from about 0.001% by weight to about 1% by weight, based on the total weight of the pigment, of at least one polyhydric alcohol deposited on the surfaces of said titanium dioxide particles.

17. A method of forming a dry anti-corrosion pigment for use in an aqueous-based coating composition, comprising:
providing a plurality of titanium dioxide particles;
providing at least one non-volatile, organic hydroxyl amine;
providing at least one organic dispersant, wherein said organic dispersant is selected from the group consisting of low molecular weight organic dispersants, organic polymeric dispersants, and combinations thereof, and wherein:
said low molecular weight organic dispersants are molecules that contain one or more functional groups derived from compounds selected from the group consisting of phosphonic acids, phosphoric acids, phosphonate-based carboxylic acids, salts of such compounds, and combinations thereof; and
said organic polymeric dispersants are polymeric molecules that contain one or more functional groups derived from compounds selected from the group consisting of phosphonic acids, phosphoric acids, phosphonate-based carboxylic acids, salts of such compounds, and combinations thereof;
depositing said non-volatile, organic hydroxyl amine on the surfaces of said titanium dioxide particles in an amount in the range of from about 0.05% by weight to about 1% by weight, based on the total weight of the pigment; and
depositing said organic dispersant on the surfaces of said titanium dioxide particles in an amount in the range of from about 0.02% by weight to about 1% by weight, based on the total weight of the pigment; and
drying said titanium dioxide particles having said non-volatile, organic hydroxyl amine and said organic dispersant thereon to form said dry anti-corrosion pigment.

18. The method of claim 17, wherein said titanium dioxide particles are raw titanium dioxide particles, and said method further comprises:
prior to depositing said non-volatile, organic hydroxyl amine and said organic dispersant on said surfaces of said raw titanium dioxide particles, grinding said titanium dioxide particles to a desired particle size and filtering and washing said ground titanium dioxide particles to form a wet pigment filter cake;
wherein said non-volatile, organic hydroxyl amine and said organic dispersant are deposited on said surfaces of said titanium dioxide particles by mixing said dispersant package with said wet pigment filter cake.

19. The method of claim 18, further comprising:
drying said wet pigment filter cake to form a dried pigment filter cake;
crushing said dried pigment filter cake to form a crushed pigment filter cake; and
steam micronizing said crushed filter cake to form said anti-corrosion pigment.

20. A method of forming an aqueous-based coating composition, comprising:
providing an aqueous mixture;
providing an anti-corrosion pigment, wherein said anti-corrosive pigment is in dry form; and
dispersing said anti-corrosive pigment in said aqueous mixture, said anti-corrosive pigment including:
a plurality of titanium dioxide particles;
in the range of from about 0.05% by weight to about 1% by weight, based on the total weight of the pigment, of at least one non-volatile, organic hydroxyl amine deposited on the surfaces of said titanium dioxide particles; and
in the range of from about 0.02% by weight to about 1% by weight, based on the total weight of said pigment, of at least one organic dispersant deposited on the surfaces of said titanium dioxide particles, wherein said organic dispersant is selected from the group consisting of low molecular weight organic dispersants, organic polymeric dispersants, and combinations thereof, and wherein:
said low molecular weight organic dispersants are molecules that contain one or more functional groups derived from compounds selected from the group consisting of phosphonic acids, phosphoric acids, phosphonate-based carboxylic acids, salts of such compounds, and combinations thereof; and
said organic polymeric dispersants are polymeric molecules that contain one or more functional groups derived from compounds selected from the group consisting of phosphonic acids, phosphoric acids, phosphonate-based carboxylic acids, salts of such compounds, and combinations thereof.
